(19) United States
(12) Patent Application Publication
(10) Pub. No.: US 2010/0121632 A1
(43) Pub. Date: May 13, 2010

(54) STEREO AUDIO ENCODING DEVICE, STEREO AUDIO DECODING DEVICE, AND THEIR METHOD

(75) Inventor: Kok Seng Chong, Singapore (SG)

Correspondence Address: GREENBLUM & BERNSTEIN, P.L.C., 1950 ROLAND CLARKE PLACE, RESTON, VA, 20191, US

(73) Assignee: PANASONIC CORPORATION, Osaka (JP)

(21) Appl. No.: 12/597,037

(22) PCT Filed: Apr. 24, 2008
(86) PCT No.: PCT/JP2008/001080

§ 371 Date: Oct. 22, 2009

(30) Foreign Application Priority Data
Apr. 25, 2007 (JP) 2007-115660

(51) Int. Cl. G10L 19/04; G10L 11/04

(52) U.S. Cl. 704/200.1; 704/205; 704/207; 704/E19.023

(57) ABSTRACT

Provided is a stereo audio encoding device which can improve the ICP (Inter-channel Prediction) performance of a stereo audio signal while suppressing the bit rate. The device (100) includes: a QMF analysis unit (101) which divides two channel signals constituting a stereo audio signal into a plurality of frequency band signals; a monaural signal generation unit (104) which generates a monaural signal by averaging the two channel signals of the divided frequency bands; parameter band constituting units (102, 105) each of which collects one or more of the continuous frequency bands to constitute a parameter band in such a manner that less bands are contained in a lower frequency for the two channel signals and monaural signals of the divided frequency bands; and an ICP analysis unit (106) which performs inter-channel prediction by using the channel signal and the monaural signal of the divided frequency bands.

### TECHNICAL FIELD

The present invention relates to a stereo speech coding apparatus that encodes stereo speech signals, stereo speech decoding apparatus supporting the stereo speech coding apparatus, and stereo speech coding and decoding methods.

### BACKGROUND ART

Communication in a monophonic scheme (i.e. monophonic communication) such as a telephone call by mobile telephones is presently the mainstream in speech communication in a mobile communication system. However, if the transmission bit rate becomes higher in the future, such as with fourth-generation mobile communication systems, it is possible to secure a band to transmit a plurality of channels, so that communication in a stereophonic scheme (i.e. stereophonic communication) is expected to become widespread in speech communication.

For example, taking into account the current situation in which a growing number of users record music in a portable audio player with a built-in HDD (Hard Disk Drive) and enjoy stereo music by plugging stereo earphones or headphones in this player, a future lifestyle can be predicted in which a mobile telephone and music player are combined and in which it is common practice to perform stereo speech communication using equipment such as stereo earphones or headphones.

Even if stereo communication becomes widespread, monophonic communication will still be performed. Because monophonic communication has a lower bit rate and is therefore expected to offer lower communication costs, while mobile telephones supporting only monophonic communication has the smaller circuit scale and is therefore less expensive, and therefore users not requiring high-quality speech communication will probably purchase mobile phones supporting only monophonic communication. That is, in one communication system, mobile phones supporting stereo communication and mobile phones supporting monophonic communication exist separately, and, consequently, the communication system needs to support both stereo communication and monophonic communication. Furthermore, in a mobile communication system, depending on the propagation environment, part of communication data may be lost because communication data is exchanged by radio signals. Thus, even if part of communication data is lost, when a mobile phone is provided with a function of reconstructing the original communication data from remaining received data, it is extremely useful. As a function to support both stereo communication and monophonic communication and allow reconstruction of original communication data from receive data remaining after some communication data is lost, there is scalable coding, which supports both stereo signals and monaural signals.

In this scalable coding, techniques for synthesizing stereo signals from monaural signals include, for example, ISC (Intensity Stereo Coding) used in MPEG-2/4 AAC (Moving Picture Experts Group 2/4 Advanced Audio Coding), disclosed in Non-Patent Document 1, MPEG 4-enhanced AAC, disclosed in Non-Patent Document 2, and BCC (Binaural Cue Coding) used in MPEG surround, disclosed in Non-Patent Document 3. In these kinds of coding, when the left channel signal and right channel signal of a stereo signal are reconstructed from a monaural signal, the energy of the monaural signal is distributed between the right and left channel signals to be decoded, such that the energy ratio between the decoded right and left channel signals is equal to the energy ratio between the original left and right channel signals encoded in the coding side. Further, to enhance the sound width in these kinds of coding, reverberation components are added to reconstructed signals using a decorrelator.

Also, as another method of reconstructing a stereo signal such as the left channel signal and right channel signal from a monaural signal, there is ICP (Inter-Channel Prediction), whereby the right and left channel signals of a stereo signal are reconstructed by applying FIR (Finite Impulse Response) filtering processing to a monaural signal. Filter coefficients of a FIR filter used in ICP coding to perform coding utilizing ICP, are determined based on the least mean squared error (“MSE”) such that the least mean squared error between the monaural signal and stereo signal is minimum. This stereo coding of an ICP scheme is suitable for encoding a signal with energy concentrated in lower frequencies, such as a speech signal.

Further, to improve ICP prediction performance in ICP coding, it is possible to adopt a method of combining ICP coding with multiband coding, that is, a method of combining ICP coding with a scheme of performing coding after dividing a stereo signal into a plurality of frequency band signals representing narrowband frequency spectral components, whereby ICP coding is performed on a per frequency band signal basis. As understood from the Nyquist theorem, a narrowband signal requires lower sampling frequencies than a wideband signal, and, consequently, the stereo signal of each frequency band subjected to down-sampling by frequency band division is represented by a smaller number of samples, so that it is possible to improve ICP prediction performance in ICP coding.

Non-Patent Document 1: General Audio Coding AAC, TwinVQ, BSAC, ISO/IEC, 14496-3: part 3, subpart 4, 2005

### Non-Patent Document 2: Parametric Coding for High Quality Audio, ISO/IEC, 14496-3, 2004

### Non-Patent Document 3: MPEG Surround, ISO/IEC, 23003-1, 2006

### DISCLOSURE OF INVENTION

### Problems to be Solved by the Invention

However, in a method of dividing a stereo signal into a plurality of frequency band signals representing narrowband frequency spectral components and performing ICP coding on a per frequency band basis, the same number of sets of ICP filter coefficients as the number of frequency bands need to be transmitted, and, consequently, there arises a problem of increased coding bit rate.

It is therefore an object of the present invention to provide a stereo speech coding apparatus, stereo speech decoding apparatus and stereo speech coding and decoding methods that reduce the number of sets of ICP filter coefficients required for transmission, reduce the bit rate and improve ICP performance of stereo speech signals, in the processing of dividing the stereo speech signals into frequency band signals and performing ICP coding.

### Means for Solving the Problem

The stereo speech coding apparatus of the present invention employs a configuration having: a frequency band dividing section that divides two channel signals forming a stereo speech signal into a plurality of frequency band signals; a monaural signal generating section that generates monaural signals using the two channel signals on a per frequency band basis; a parameter band forming section that forms parameter bands by grouping one or a plurality of consecutive frequency bands such that a number of frequency bands included in parameter bands of lower frequencies decreases; an inter-channel prediction analysis section that performs an inter-channel prediction analysis on a per parameter band basis, using the two channel signals and the monaural signals of the frequency bands, and acquires inter-channel prediction coefficients; an inter-channel prediction coefficient encoding section that encodes the inter-channel prediction coefficients; a frequency band synthesis section that synthesizes the monaural signals of the frequency bands and generates a monaural signal of an entire band; and a monaural signal encoding section that encodes the monaural signal of the entire band.

The stereo speech decoding apparatus of the present invention employs a configuration having: a receiving section that receives monaural signal coded information and inter-channel prediction coefficient coded information, the monaural signal coded information being acquired by encoding a monaural signal acquired using two channel signals forming a stereo speech signal, and the inter-channel prediction information being acquired by encoding inter-channel prediction coefficients acquired by performing an inter-channel prediction analysis of the two channel signals and the monaural signal divided into a plurality of frequency band signals; a monaural signal decoding section that decodes the monaural signal coded information and acquires the monaural signal; an inter-channel prediction coefficient decoding section that decodes the inter-channel prediction coefficient coded information and acquires the inter-channel prediction coefficients; a frequency band dividing section that divides the monaural signal into a plurality of frequency bands; a parameter band forming section that forms parameter bands by grouping one or a plurality of consecutive frequency bands such that a number of frequency bands included in parameter bands of lower frequencies decreases; an inter-channel prediction synthesis section that performs an inter-channel prediction on a per parameter band basis, using the monaural signals of the frequency bands and the inter-channel prediction coefficients, and acquires the two channel signals of the frequency bands; and a frequency band synthesis section that generates a signal of an entire band from each of the two channel signals of the frequency bands.

The stereo speech coding method of the present invention includes the steps of: dividing two channel signals forming a stereo speech signal into a plurality of frequency band signals; generating monaural signals using the two channel signals on a per frequency band basis; forming a parameter band by grouping one or a plurality of consecutive frequency bands such that a number of frequency bands included in parameter bands of lower frequencies decreases; performing an inter-channel prediction analysis on a per parameter band basis, using the two channel signals and the monaural signals of the frequency bands, and acquiring inter-channel prediction coefficients; encoding the inter-channel prediction coefficients; synthesizing the monaural signals of the frequency bands and generates a monaural signal of an entire band; and encoding the monaural signal of the entire band.

### Advantageous Effect of Invention

According to the present invention, the coding apparatus side reduces the number of sets of ICP filter coefficients required for transmission, thereby reducing the bit rate and improving ICP prediction performance with respect to stereo signals. By this means, the decoding side can decode stereo speech signals with high quality.

### BRIEF DESCRIPTION OF DRAWINGS

FIG. 1 is a block diagram showing the main components of a stereo speech coding apparatus according to Embodiment 1 of the present invention;

FIG. 2 is a diagram illustrating the operations of the sections of a stereo speech coding apparatus according to Embodiment 1 of the present invention;

FIG. 3 is a block diagram showing the main components of a stereo speech decoding apparatus according to Embodiment 1 of the present invention;

FIG. 4 is a block diagram showing the main components of a variation of stereo speech coding apparatus according to Embodiment 1 of the present invention;

FIG. 5 is a block diagram showing the main components of a variation of stereo speech coding apparatus according to Embodiment 1 of the present invention;

FIG. 6 is a block diagram showing the main components of a variation of stereo speech decoding apparatus according to Embodiment 1 of the present invention;

FIG. 7 is a block diagram showing the main components of a stereo speech coding apparatus according to Embodiment 2 of the present invention; and

FIG. 8 is a diagram illustrating a forming result of parameter bands acquired in a parameter forming section according to Embodiment 2 of the present invention.

### BEST MODE FOR CARRYING OUT THE INVENTION

Primary features of the present invention include dividing a time domain stereo speech signal into a plurality of frequency band signals, forming parameter bands by grouping one or a plurality of consecutive frequency bands such that the number of frequency bands included in parameter bands of lower frequencies decreases, and performing an ICP analysis on a per parameter band basis. By this means, the coding apparatus side reduces the number of sets of ICP filter coefficients required for transmission, thereby reducing the bit rate and improving ICP prediction performance with respect to stereo signals. By this means, the decoding side can decode stereo speech signals with high quality.

Embodiments of the present invention will be explained below in detail with reference to the accompanying drawings.

### Embodiment 1

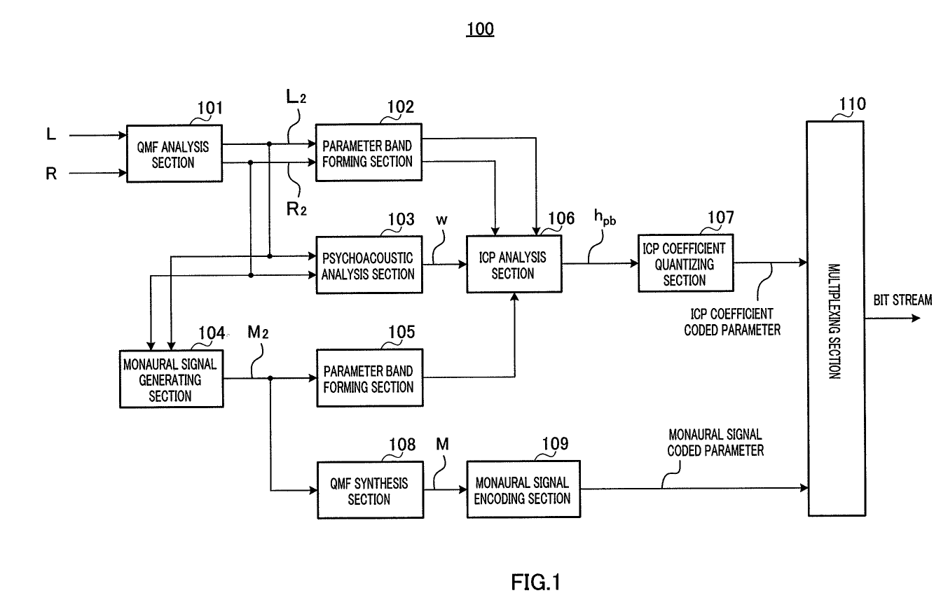

FIG. 1 is a block diagram showing the main components of stereo speech coding apparatus 100 according to Embodiment 1 of the present invention. An example case will be explained below where a stereo signal is comprised of two channels of the left channel and right channel. Here, the descriptions of “left channel,” “right channel,” “L” and “R” are used for ease of explanation and do not necessarily limit the positional conditions of right and left.

In FIG. 1, stereo speech coding apparatus 100 is provided with QMF (Quadrature Mirror Filter) analysis section 101, parameter band forming section 102, psychoacoustic analysis section 103, monaural signal generating section 104, parameter band forming section 105, ICP analysis section 106, ICP coefficient quantizing section 107, QMF synthesis section 108, monaural signal encoding section 109 and multiplexing section 110.

QMF analysis section 101, formed with a QMF analysis filter bank, divides original signals, that is, the left channel signal L and right channel signal R in the time domain, received as input in stereo speech coding apparatus 100, into a plurality of frequency band signals representing narrowband frequency spectral components of the left channel signal L and right channel signal R in the time domain, and outputs the results to parameter band forming section 102, psychoacoustic analysis section 103 and monaural signal generating section 104.

Parameter band forming section 102 forms parameter bands by grouping a plurality of consecutive frequency bands of the left channel signals L₂ and right channel signals R₂ of divided frequency bands received as input from QMF analysis section 101, and outputs the formed parameter band signals to ICP analysis section 106. Here, a parameter band refers to a group of a plurality of frequency bands subject to an ICP analysis by a common set of ICP coefficients, and parameter band forming section 102 forms a parameter band with one or a plurality of consecutive frequency bands such that the number of frequency bands included in parameter bands of lower frequencies decreases.

Psychoacoustic analysis section 103 performs a psychoacoustic analysis of the left channel signals L₂ and right channel signals R₂ of divided frequency bands received as input from QMF analysis section 101, generates an error weighting coefficient w so as to further emphasize the contribution of frequency band with higher energy to error evaluation in least mean squared error processing for calculating inter-channel prediction coefficients, and outputs the error weighting coefficient w to ICP analysis section 106.

Monaural signal generating section 104 generates the average values of the left channel signals L₂ and right channel signals R₂ of divided frequency bands received as input from QMF analysis section 101, as monaural signals M₂, and outputs them to parameter band forming section 105 and QMF synthesis section 108.

Parameter band forming section 105 forms parameter bands using a plurality of consecutive frequency bands in the frequency bands forming the monaural signals M₂ received as input from monaural signal generating section 104, and outputs the formed parameter bands to ICP analysis section 106.

ICP analysis section 106 performs an ICP analysis on a per parameter band basis, using the error weighting coefficient w received as input from psychoacoustic analysis section 103, the left channel signals L₂ and right channel signals R₂ of divided parameter bands received as input from parameter band forming section 102, and the monaural signals M₂ of parameter bands received as input from parameter band forming section 105, and outputs the resulting ICP coefficient h_{pb} to ICP coefficient quantizing section 107.

ICP coefficient quantizing section 107 quantizes the ICP coefficient received as input from ICP analysis section 106, and outputs the resulting ICP coefficient coded parameter to multiplexing section 110.

QMF synthesis section 108 is formed with a QMF synthesis filter bank, generates the monaural signal M of the entire band by performing a synthesis using the monaural signals M₂ of divided frequency bands received as input from monaural signal generating section 104, and outputs the result to monaural signal encoding section 109.

Monaural signal encoding section 109 encodes the monaural signal M received as input from QMF synthesis section 108 and outputs the resulting monaural signal coded parameter to multiplexing section 110.

Multiplexing section 110 multiplexes the ICP coefficient coded parameter received as input from ICP coefficient quantizing section 107 and the monaural signal coded parameter received as input from monaural signal coding section 109, and outputs the resulting bit stream to stereo speech decoding apparatus 200, which will be described later.

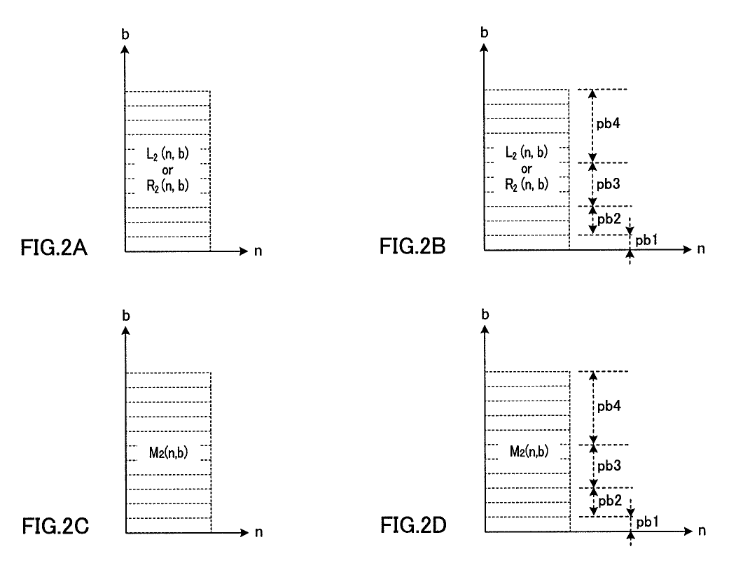

FIG. 2 is a diagram illustrating the operations of the sections of stereo speech coding apparatus 100. The operations of the sections of stereo speech coding apparatus 100 shown in FIG. 1 will be explained below in detail.

QMF analysis section 101 divides the left channel signal L(n) and right channel signal R(n), received as input in stereo speech coding apparatus 100, into a plurality of frequency band signals, and acquires the left channel signal L₂ (n, b) and right channel signal R₂ (n, b), as shown in FIG. 2A. Here, “n” represents a sample number of signal, and “b” represents a band number of a plurality of frequency bands (the same applies to FIG. 2B, FIG. 2C and FIG. 2D).

Parameter band forming section 102 forms parameter bands pb1 to pb4 as shown in FIG. 2B, using a plurality of frequency bands of the left channel signal L₂ (n, b) and right channel signal R₂ (n, b) generated in QMF analysis section 101 as shown in FIG. 2A. As shown in FIG. 2, parameter band forming section 102 forms parameter bands by grouping one or a plurality of frequency bands such that the number of frequency bands included in parameter bands of lower frequencies decreases.

Psychoacoustic analysis section 103 performs a psychoacoustic analysis of the left channel signals L₂ and right channel signals R₂ generated in QMF analysis section 101, and generates an error weighting coefficient w. The error weighting coefficient w generated in psychoacoustic analysis section 103 will be described later in detail.

Monaural signal generating section 104 generates the monaural signal M₂ (n, b) according to following equation 1, using the left channel signal L₂ (n, b) and right channel signal R₂ (n, b) generated in QMF analysis section 101.

M₂(n,b)=(L₂(n,b)+R₂(n,b))/2 (Equation 1)

FIG. 2C is a diagram illustrating the monaural signal M₂ (n, b) generated in monaural signal generating section 104. As shown in FIG. 2A and FIG. 2C, a plurality of frequency bands forming the monaural signal M₂ (n, b) are the same as the plurality of frequency bands forming the left channel signal L₂ (n, b) or right channel signal R₂ (n, b).

Parameter band forming section 105 forms a plurality of parameter bands using the plurality of frequency bands of the monaural signal M₂ (n, b) generated in monaural signal generating section 104. FIG. 2D is a diagram illustrating the plurality of parameters of the monaural signal M₂ (n, b) generated in parameter band forming section 105. A shown in FIG. 2B and FIG. 2D, the method of forming parameter bands of the monaural signal M₂ (n, b) is the same as the method of forming parameter bands of the left channel signal L₂ (n, b) or right channel signal R₂ (n, b). That is, a plurality of frequency bands included in the parameter bands of the monaural signal M₂ (n, b) are the same as a plurality of frequency bands included in the parameter bands of the left channel signal L₂ (n, b) or right channel signal R₂ (n, b).

ICP analysis section 106 performs an ICP analysis on a per parameter band basis, using the left channel signal L₂ (n, b) and right channel signal R₂ (n, b) of divided frequency band received as input from parameter band forming section 102 and the monaural signal M₂ (n, b) of divided frequency band received as input from parameter band forming section 105, and determines the ICP coefficient h_{pb} that minimizes the mean squared error ξ(pb) shown in following equation 2.

$$\begin{matrix}ξ ( pb ) = {\sum }_{b ⋐ pb} ξ ( b ) w ( b ) \\ = {\sum }_{b ⋐ pb} {\sum }_{n} {( \begin{matrix}{s}_{2} ( n , b ) - \\ {\sum }_{i} {h}_{pb} ( i ) m ( n - i , b )\end{matrix} )}^{2} w ( b )\end{matrix} \qquad ( Equation 2 )$$

In equation 2, s₂ (n, b) represents the left channel signal L₂ (n, b) or right channel signal R₂ (n, b) of divided frequency band, m (n, b) represents the monaural signal M₂ (n, b) of divided frequency band, “i” represents an index of the i-th order of FIR filter coefficients and “pb” represents the parameter band number. As shown in equation 2, in each parameter band pb, ICP analysis section 106 finds, as ICP coefficients, the FIR filter coefficient h_{pb} (i) to predict the left channel signal L₂ (n, b) or right channel signal R₂ (n, b) of divided frequency band from the monaural signal m₂ (n, b) of divided frequency band. Also, as shown in equation 2, a plurality of frequency bands included in the same parameter band share a common set of ICP coefficients. By calculating equation 2, h_{pb} represented by equation 3 is found.

$$⇒ \frac{\partial ξ ( {h}_{pb} )}{\partial ( {h}_{pb} )} = 0 \\ ⇒ {h}_{pb}^{T} ( {\sum }_{b ⋐ pb} w ( b ) T ( b ) ) = ( {\sum }_{b ⋐ pb} w ( b ) t ( b ) ) \\ ⇒ {h}_{pb} = {( {\sum }_{b ⋐ pb} w ( b ) T ( b ) )}^{- 1} ( {\sum }_{b ⋐ pb} w ( b ) t ( b ) ) \qquad ( Equation 3 )$$

In equation 3, T(b) and t(b) are represented by following equation 4 and equation 5, respectively.

$$\begin{matrix}T ( b ) = {\sum }_{n} m ( n - i , b ) m ( n - j , b ) & ( Equation 4 ) \\ t ( b ) = {\sum }_{n} {s}_{2} ( n , b ) m ( n - j , b ) & ( Equation 5 )\end{matrix}$$

In the ICP analysis using above equation 2 to 5, least mean squared error processing is adjusted using the error weighting coefficient wt(b) represented by following equation 6.

$$wt ( b ) = β {\sum }_{n} {\vert {s}_{2} ( n , b ) \vert}^{2} + α \qquad ( Equation 6 )$$

In equation 6, α and β are tuning coefficients.

The error weighting coefficient w used in ICP analysis section 106 according to the present embodiment is generated in psychoacoustic analysis section 103, and, taking into account that a band in which the energy of an input signal is higher is perceptually more important than a band in which the energy of the input signal is lower, psychoacoustic analysis section 103 finds the error weighting coefficient w so as to emphasize the contribution of band of higher energy to an error evaluation in least mean squared error processing. One such example is the error weighting coefficient wt shown in equation 6.

ICP coefficient quantizing section 107 quantizes the ICP coefficient h_{pb} generated in ICP analysis section 106 and acquires the ICP coefficient coded parameter.

QMF synthesis section 108 synthesizes all of monaural signal M₂ (n, b) per divided frequency band, generated by monaural signal generating section 104, and generates the monaural signal M(n) of the entire band.

Monaural signal encoding section 109 performs CELP (Code Excited Linear Prediction) coding of the monaural signal M(n) generated in QMF synthesis section 108, and acquires the monaural signal coded parameter.

Multiplexing section 110 multiplexes the ICP coefficient coded parameter generated in ICP coefficient quantizing section 107 and the monaural signal coded parameter generated in monaural signal encoding section 109, and outputs the resulting bit stream to stereo speech decoding apparatus 200.

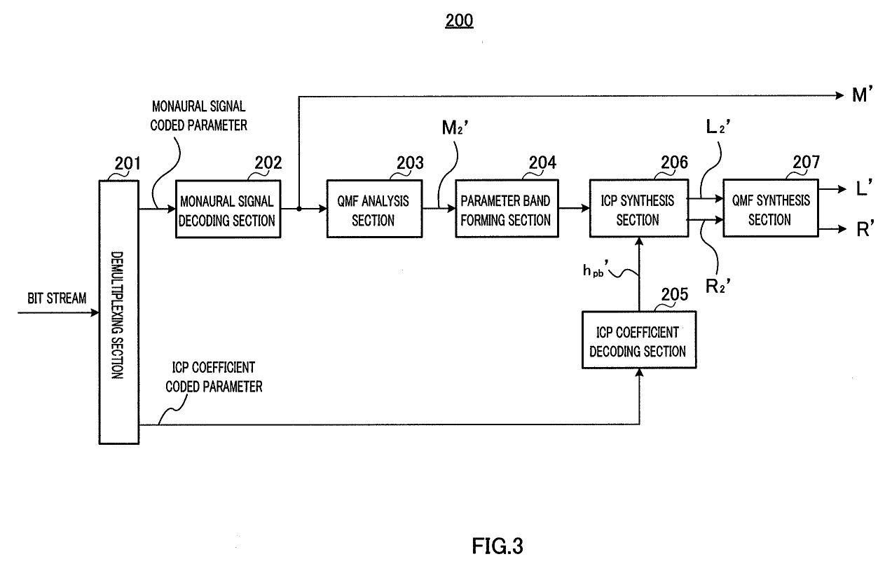

FIG. 3 is a block diagram showing the main components of stereo speech decoding apparatus 200 according to the present embodiment.

In FIG. 3, stereo speech decoding apparatus 200 is provided with demultiplexing section 201, monaural signal decoding section 202, QMF analysis section 203, parameter band forming section 204, ICP coefficient decoding section 205, ICP synthesis section 206 and QMF synthesis section 207.

Demultiplexing section 201 demultiplexes the bit stream transmitted from stereo speech coding apparatus 100 into the monaural signal coded parameter and ICP coefficient coded parameter, and outputs these parameters to monaural signal decoding section 202 and ICP coefficient decoding section 205, respectively.

Monaural signal decoding section 202 performs CELP decoding using the monaural signal coded parameter received as input from demultiplexing section 201, outputs the resulting decoded monaural signal M′(n) to QMF analysis section 203 and outputs it to the outside of stereo speech decoding apparatus 200 if necessary.

QMF analysis section 203 is comprised of a QMF analysis filter bank, and divides the time domain monaural signal M′(n) received as input from monaural signal decoding section 202 into a plurality of frequency band signals representing narrowband frequency spectrum components, and outputs the decoded monaural signal M₂′ (n, b) to parameter band forming section 204 on a per frequency band basis.

Parameter band forming section 204 performs the same processing as in parameter band forming section 105 of stereo speech coding apparatus 100, and forms a plurality of parameter bands using a plurality of frequency bands of the decoded monaural signal M₂′ (n, b) received as input from QMF analysis section 203, and outputs the parameter bands to ICP synthesis section 206.

ICP coefficient decoding section 205 decodes the ICP coefficient coded parameter received as input from demultiplexing section 201 and outputs the resulting, decoded ICP coefficient h_{pb}′ to ICP synthesis section 206.

ICP synthesis section 206 performs ICP synthesis processing on a per parameter band basis, using the decoded monaural signal M₂′ (n, b) of divided frequency band received as input from parameter band forming section 204 and the decoded ICP coefficient h_{pb}′ received as input from ICP coefficient decoding section 205, and outputs the resulting left channel signal L₂′ (n, b) and right channel signal R₂′ (n, b) of divided frequency band to QMF synthesis section 207.

QMF synthesis section 207 is formed with a QMF synthesis filter bank, and generates and outputs the left channel signal L′(n) and right channel signal R′(n) of the entire band, using all of the left channel signal L2′ (n, b) and right channel signal R2′ (n, b) per divided frequency band received as input from ICP synthesis section 206.

Thus, according to the present embodiment, the stereo speech coding apparatus divides a time domain stereo signal into frequency band signals of narrow bands requiring a smaller number of samples than a wide band, and further performs an inter-channel prediction in units of parameter bands formed with a plurality of consecutive frequency bands. Therefore, by sharing a common set of inter-channel prediction coefficients in a plurality of consecutive frequency bands, it is possible to reduce the number of sets of channel prediction coefficients required for transmission, compared to a case where an inter-channel prediction is performed on a per frequency band basis, thereby further reducing the bit rate of stereo speech coding. Further, upon forming parameter bands, taking into account that lower frequencies are perceptually more important, the stereo speech coding apparatus forms the parameter bands and performs an inter-channel prediction with higher prediction performance such that the number of frequency bands included in parameter bands of lower frequencies decreases, thereby reducing the bit rate of stereo speech coding and further improving coding performance. As a result, the stereo speech decoding apparatus according to the present embodiment can decode speech signals of high quality.

Also, according to the present embodiment, upon performing an inter-channel prediction, taking into account that frequencies with higher energy are perceptually more important, an error weighting coefficient is found so as to further emphasize the contribution of frequency band of higher energy to an error evaluation in least mean squared error processing. By this means, it is possible to further improve inter-channel prediction performance and further improve stereo speech coding performance, so that the decoding apparatus can provide decoded speech signals of high quality.

Also, an example case has been described with the present embodiment where an error weight coefficient w is found so as to emphasize the contribution of frequency band of higher energy to an error evaluation in least mean squared error processing, the present invention is not limited to this, and it is equally possible to perform an ICP analysis using a higher ICP order in a frequency band with higher energy. By this means, it is possible to reduce the bit rate and improve ICP performance (i.e. stereo speech coding performance), so that the decoding apparatus can provide decoded speech signals of high quality.

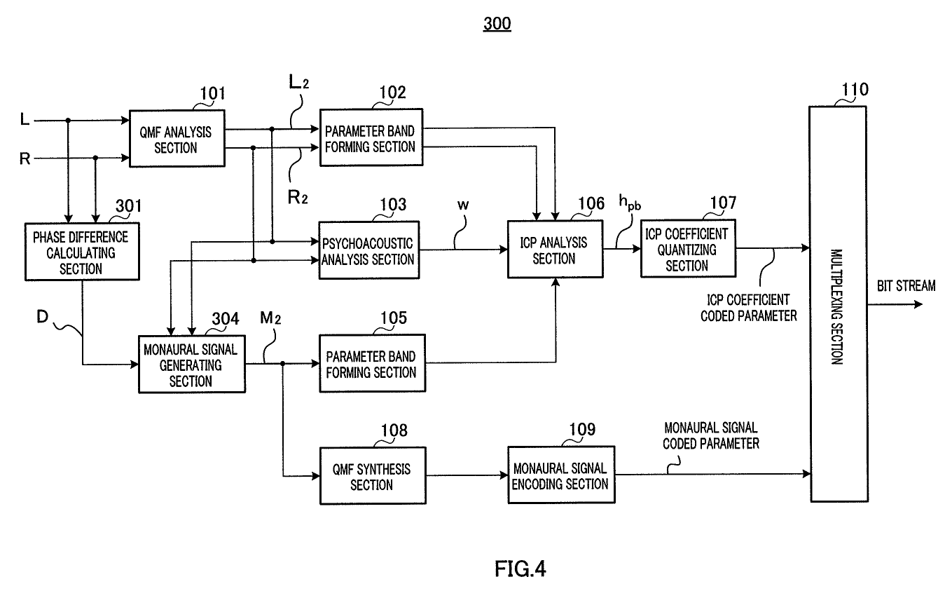

Also, an example case has been described with the present embodiment where the time delay difference between the left channel signal L and the right channel signal R is not taken into account upon generating a monaural signal, the present invention is not limited to this, and it is possible to further improve the accuracy of stereo speech coding by correcting this time delay difference. FIG. 4 is a block diagram showing the main components of stereo speech coding apparatus 300 to correct the time delay difference as above. Stereo speech coding apparatus 300 has the same basic configuration as stereo speech coding apparatus 100 according to the present embodiment (see FIG. 1), and the same components will be assigned the same reference numerals. Stereo speech coding apparatus 300 differs from stereo speech coding apparatus 100 in having an addition of phase difference calculating section 301, and, part of processing in monaural signal generating section 304 differs from monaural signal generating section 104 of stereo speech coding apparatus 100.

It takes different propagation times until speech from the same source reaches the stereo microphone in a stereo speech coding system via different paths of the left channel and right channel, and therefore a time delay difference is caused between the left channel signal L and the right channel signal R. If the time delay difference stays within one sample delay in a divided frequency band signal subjected to QMF processing, this time difference can be represented in the form of the phase difference between L₂′ (n, b) and R₂′ (n, b). This phase difference D is calculated based on following equation 7 and outputted to monaural signal generating section 304.

$${e}^{j D} = \frac{{\sum }_{n} L \cdot {R}^{*}}{\sqrt{{\sum }_{n} {\vert L \vert}^{2} {\sum }_{n} {\vert R \vert}^{2}}} \qquad ( Equation 7 )$$

In equation 7, “D” represents the phase difference between L₂′ (n, b) and R₂′ (n, b). Monaural signal generating section 304 generates the monaural signal M₂ where the phase difference represented by equation 7 is removed, according to the following equation 8. By this means, it is possible to further improve ICP performance and further improve stereo speech coding performance.

M(n,b)=(L(n,b)·e^{j(-0.5D)}+R(n,b)·e^{j(+0.5D)}/2 (Equation 8)

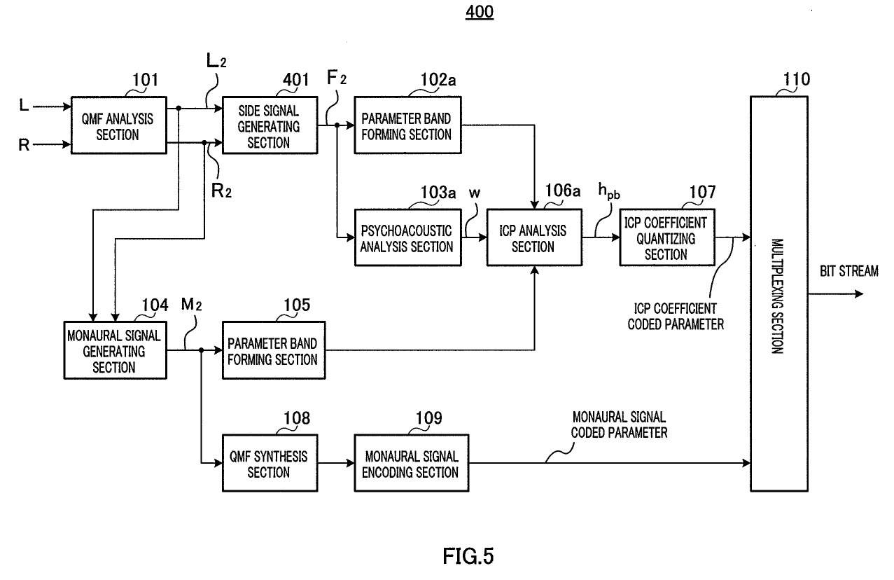

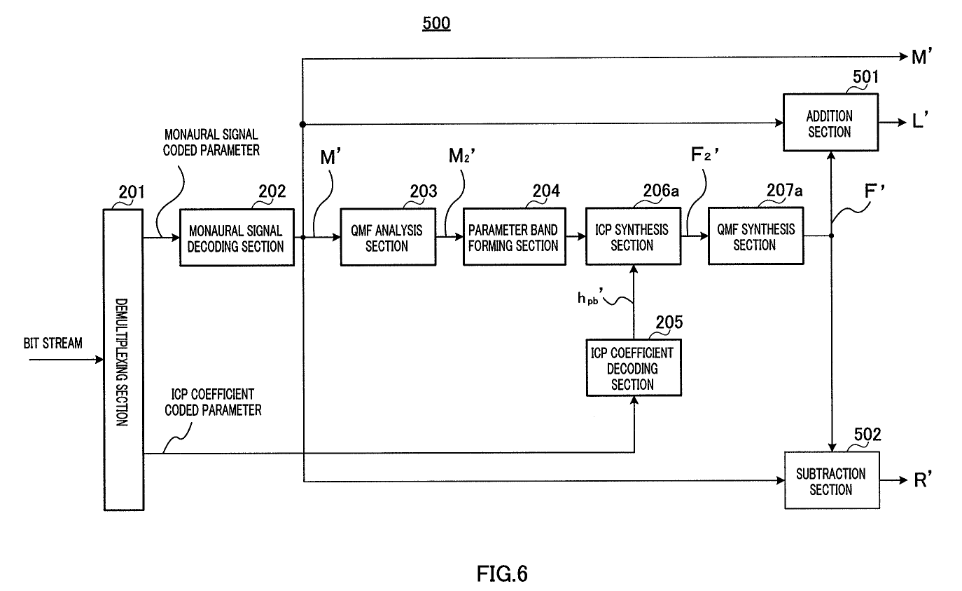

Also, although an example case has been described above with the present embodiment where an inter-channel prediction of the left channel signal or the right channel signal is performed using a monaural signal, the present invention is not limited to this, and it is equally possible to find a half of the difference signal between the left channel signal and the right channel signal, as a side signal, and perform an inter-channel prediction of the side signal using a monaural signal. In this case, stereo speech coding apparatus employs the configuration shown in FIG. 5, and stereo speech decoding apparatus 500 shown in FIG. 6 employs the configuration shown in FIG. 6. Stereo speech coding apparatus 400 and stereo speech decoding apparatus 500 have the same basic configuration as stereo speech coding apparatus 100 (see FIG. 1) and stereo speech decoding apparatus 200 (see FIG. 3), respectively, and the same components will be assigned the same reference numerals. Stereo speech coding apparatus 400 differs from stereo speech coding apparatus 100 mainly in further providing side signal generating section 401, and stereo speech decoding apparatus 500 differs from stereo speech decoding apparatus 200 mainly in further having addition section 501 and subtraction section 502.

In stereo speech coding apparatus 400, side signal generating section 401 finds the side signal F₂ (n, b) according to following equation 9, using the left channel signal L₂ (n, b) and right channel signal R₂ (n, b) received as input from QMF analysis section 101.

F₂(n,b)=(L₂(n,b)−R₂(n,b))/2 (Equation 9)

In stereo speech decoding apparatus 500, a signal generated by ICP synthesis processing in ICP synthesis section 206a is the decoded side signal F₂′ (n, b), and a signal generated by synthesis processing in QMF synthesis section 207a is the decoded side signal F′(n). Also, addition section 501 and subtraction section 502 finds and outputs the left channel signal L′(n) and right channel signal R′(n) according to following equation 10 and equation 11, respectively.

L′(n)=M′(n)+F′(n) (Equation 10)

R′(n)=M′(n)−F′(n) (Equation 11)

By employing the above configurations, in the same way as above, the coding apparatus can improve the coding performance and the decoding apparatus can decode speech signals of high quality.

### Embodiment 2

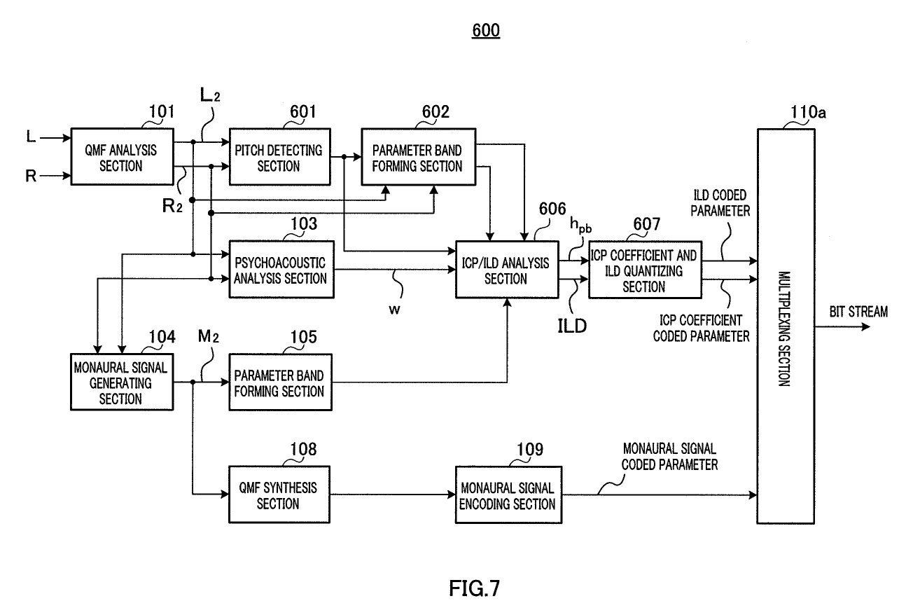

FIG. 7 is a block diagram showing the main components of stereo speech coding apparatus 600 according to the present embodiment. Here, stereo speech coding apparatus 600 has the same basic configuration as stereo speech coding apparatus 100 (see FIG. 1), and therefore the same components will be assigned the same reference numerals and their explanation will be omitted.

Stereo speech coding apparatus 600 differs from stereo speech coding apparatus 100 in further having pitch detecting section 601 and replacing ICP analysis section 106 and ICP coefficient quantizing section 107 with ICP and ILD (Inter-channel Level Difference) analysis section 606 and ICP coefficient and ILD quantizing section 607. Also, parameter band forming section 602 of stereo speech coding apparatus 600 and parameter band forming section 102 of stereo speech coding apparatus 100 are different in part of processing, and are therefore assigned different reference numerals to show the difference.

Pitch detecting section 601 detects whether or not a periodic waveform (i.e. pitch period waveform) or pitch pulse waveform is included in each of a plurality of frequency band signals of the left channel signal L2 and right channel signal R2 of divided frequency band received as input from QMF analysis section 101, classifies frequency bands including such waveforms into “pitch-like part,” classifies frequency bands not including such waveforms into “noise-like part,” and outputs the analysis result to parameter band forming section 602 and ICP/ILD analysis section 606.

Based on the analysis result of frequency bands received as input from pitch detecting section 601, parameter band forming section 602 forms parameter bands using a plurality of consecutive frequency bands classified as “pitch-like part,” and outputs the plurality of parameter bands formed to ICP/ILD analysis section 606.

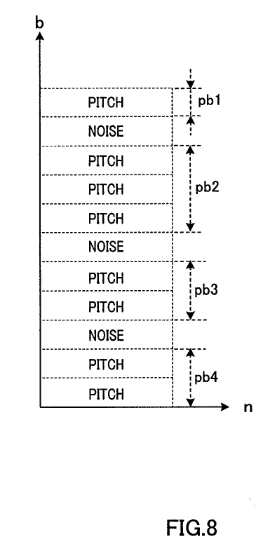

FIG. 8 is a diagram illustrating the configuration result of parameter bands acquired in parameter band forming section 602. In FIG. 8, parameter band forming section 602 forms parameter bands pb1 to pb4 using a plurality of consecutive “pitch-like” frequency bands.

Returning to FIG. 7 again, based on the analysis result of frequency bands received as input from pitch detecting section 601, ICP/ILD analysis section 606 performs the same processing as ICP analysis processing in ICP analysis section 106 of stereo speech coding apparatus 100, on the frequency bands classified as “pitch-like part,” and performs an ILD analysis of the frequency bands classified as “noise-like part.” Here, an ILD analysis is the processing of calculating the energy ratio between the left channel signal and the right channel signal, and, in this case, only the energy ratio needs to be quantized and transmitted, so that it is possible to further reduce the bit rate than in ICP analysis. With the present embodiment, ICP/ILD analysis section 606 calculates the energy ratio between the left channel signal and right channel signal of “noise-like” frequency bands, according to following equation 12. After that, ICP coefficient and ILD quantizing section 607 quantizes the ICP coefficients and ILD parameter (i.e. energy ratio) acquired from ICP/ILD analysis section 606 and outputs the results to multiplexing section 110a.

$$ILD = \frac{{\sum }_{n} {\vert {L}_{2} ( n , b ) \vert}^{2}}{{\sum }_{n} {\vert {R}_{2} ( n , b ) \vert}^{2}} \qquad ( Equation 12 )$$

In response to ILD analysis processing in stereo speech coding apparatus 600, the stereo speech decoding apparatus according to the present embodiment performs ILD synthesis processing according to following equation 13 and reconstructs the left channel signal L2′ (n, b) of divided frequency band.

$${L}_{2}^{′} ( n , b ) = {M}_{2}^{′} ( n , b ) \sqrt{\frac{ILD}{1 + ILD}} \qquad ( Equation 13 )$$

Thus, according to the present embodiment, by performing an ICP analysis for “pitch-like” frequency bands, in which a temporal change of waveforms and phase information are important for coding, on a per parameter band basis, and performing an ILD analysis, which allows coding with a smaller amount of information, for “noise-like” frequency bands in which a temporal change of waveforms and phase information are less important, the stereo speech coding apparatus can further reduce the bit rate of stereo speech coding without degrading coding performance.

Embodiments of the present invention have been described above.

In the above embodiments, L and R may be reversed. Also, although the monaural signal M represents the average value between L and R, the present invention is not limited to this, and M may be a representative value that can be adaptively calculated using L and R.

Also, although the stereo speech decoding apparatus of the present embodiment performs processing using a bit stream transmitted from the stereo speech coding apparatus according to the present embodiment, the present invention is not limited to this, and, if the bit stream includes necessary parameters and data, the processing is possible even when the bit stream is not transmitted from the stereo speech coding apparatus according to the present embodiment.

The stereo speech coding apparatus and stereo speech decoding apparatus according to the present invention can be mounted on a communication terminal apparatus in a mobile communication system, so that it is possible to provide a communication terminal apparatus having the same operational effect as described above. Also, the stereo speech coding apparatus, stereo speech decoding apparatus and these methods according to the present embodiment are available in a communication system of a wired system.

Also, although an example case has been described with the above embodiments where the preset invention is applied to monaural-to-stereo scalable coding, it is equally possible to employ a configuration where the present invention is applied to coding/decoding per band upon performing band split coding of stereo signals.

Although a case has been described above with the above embodiments as an example where the present invention is implemented with hardware, the present invention can be implemented with software. For example, by describing the stereo speech coding method according to the present invention in a programming language, storing this program in a memory and making the information processing section execute this program, it is possible to implement the same function as the stereo speech coding apparatus according to the present invention.

Furthermore, each function block employed in the description of each of the aforementioned embodiments may typically be implemented as an LSI constituted by an integrated circuit. These may be individual chips or partially or totally contained on a single chip.

“LSI” is adopted here but this may also be referred to as “IC,” “system LSI,” “super LSI,” or “ultra LSI” depending on differing extents of integration.

Further, the method of circuit integration is not limited to LSI's, and implementation using dedicated circuitry or general purpose processors is also possible. After LSI manufacture, utilization of an FPGA (Field Programmable Gate Array) or a reconfigurable processor where connections and settings of circuit cells in an LSI can be reconfigured is also possible.

Further, if integrated circuit technology comes out to replace LSI's as a result of the advancement of semiconductor technology or a derivative other technology, it is naturally also possible to carry out function block integration using this technology. Application of biotechnology is also possible.

The disclosure of Japanese Patent Application No. 2007-115660, filed on Apr. 25, 2007, including the specification, drawings and abstract, is incorporated herein by reference in its entirety.

### INDUSTRIAL APPLICABILITY

The stereo speech coding apparatus, stereo speech decoding apparatus and these methods according to the present embodiment are applicable to, for example, a communication terminal apparatus in a mobile communication system.

1. A stereo speech coding apparatus comprising:
a frequency band dividing section that divides two channel signals forming a stereo speech signal into a plurality of frequency band signals;
a monaural signal generating section that generates monaural signals using the two channel signals on a per frequency band basis;
a parameter band forming section that forms parameter bands by grouping one or a plurality of consecutive frequency bands such that a number of frequency bands included in parameter bands of lower frequencies decreases;
an inter-channel prediction analysis section that performs an inter-channel prediction analysis on a per parameter band basis, using the two channel signals and the monaural signals of the frequency bands, and acquires inter-channel prediction coefficients;
an inter-channel prediction coefficient encoding section that encodes the inter-channel prediction coefficients;
a frequency band synthesis section that synthesizes the monaural signals of the frequency bands and generates a monaural signal of an entire band; and
a monaural signal encoding section that encodes the monaural signal of the entire band.

2. The stereo speech coding apparatus according to claim 1, further comprising a psychoacoustic analysis section that performs a psychoacoustic analysis using the two channel signals of the frequency bands and generates error weighting coefficients,
wherein, upon performing the inter-channel prediction using the error prediction coefficients, the inter-channel prediction analysis section further emphasizes contribution of frequencies with higher energy to error evaluation in least mean squared error processing.

3. The stereo speech coding apparatus according to claim 1, further comprising a phase difference calculating section that calculates phase differences between the two channel signals of the frequency bands,
wherein the monaural signal generating section removes the phase differences and generates the monaural signals.

4. The stereo speech coding apparatus according to claim 1, further comprising a pitch detecting section that detects whether or not each of the frequency bands includes a waveform with a pitch period or a waveform with a pitch pulse, classifies frequency bands including the waveform with the pitch period or the waveform with the pitch pulse into pitch-like frequency bands, and classifies frequency bands not including the waveform with the pitch period or the waveform with the pitch pulse into noise-like frequency bands, wherein:
the parameter band forming section forms the parameter bands using a plurality of consecutive pitch-like frequency bands in the pitch-like frequency bands; and
the inter-channel prediction analysis section performs the inter-channel prediction analysis on a per parameter band basis in the pitch-like frequency bands, using the two channel signals and the monaural signals, and finds energy ratios between the two channel signals in the noise-like frequency bands.

5. A stereo speech decoding apparatus comprising:
a receiving section that receives monaural signal coded information and inter-channel prediction coefficient coded information, the monaural signal coded information being acquired by encoding a monaural signal acquired using two channel signals forming a stereo speech signal, and the inter-channel prediction information being acquired by encoding inter-channel prediction coefficients acquired by performing an inter-channel prediction analysis of the two channel signals and the monaural signal divided into a plurality of frequency band signals;
a monaural signal decoding section that decodes the monaural signal coded information and acquires the monaural signal;
an inter-channel prediction coefficient decoding section that decodes the inter-channel prediction coefficient coded information and acquires the inter-channel prediction coefficients;
a frequency band dividing section that divides the monaural signal into a plurality of frequency bands;
a parameter band forming section that forms parameter bands by grouping one or a plurality of consecutive frequency bands such that a number of frequency bands included in parameter bands of lower frequencies decreases;
an inter-channel prediction synthesis section that performs an inter-channel prediction on a per parameter band basis, using the monaural signals of the frequency bands and the inter-channel prediction coefficients, and acquires the two channel signals of the frequency bands; and
a frequency band synthesis section that generates a signal of an entire band from the two channel signals of the frequency bands.

6. A stereo speech coding method comprising the steps of:
dividing two channel signals forming a stereo speech signal into a plurality of frequency band signals;
generating monaural signals using the two channel signals on a per frequency band basis;
forming a parameter band by grouping one or a plurality of consecutive frequency bands such that a number of frequency bands included in parameter bands of lower frequencies decreases;
performing an inter-channel prediction analysis on a per parameter band basis, using the two channel signals and the monaural signals of the frequency bands, and acquiring inter-channel prediction coefficients;
encoding the inter-channel prediction coefficients;
synthesizing the monaural signals of the frequency bands and generates a monaural signal of an entire band; and
encoding the monaural signal of the entire band.
